(19) United States
(12) Patent Application Publication
(10) Pub. No.: US 2012/0266619 A1
(43) Pub. Date: Oct. 25, 2012

(54) COOLING SYSTEM FOR USE IN AN APPLIANCE AND METHOD OF ASSEMBLING SAME

(76) Inventor: Bradley Douglas Shaw, Plaistow, NH (US)

(21) Appl. No.: 13/091,528

(22) Filed: Apr. 21, 2011

(51) Int. Cl. F25B 49/00; F25D 17/04; B23P 15/26; F25D 17/00

(52) U.S. Cl. 62/126; 62/452; 62/454; 62/129; 29/890.035

(57) ABSTRACT

A cooling system for use in cooling an interior volume. The cooling system includes a first cooling assembly that is positioned within a housing that defines the interior volume. The first cooling assembly facilitates cooling the interior volume of the housing. A second cooling assembly is positioned external to the housing in flow communication with the first cooling assembly. The second cooling assembly is configured to channel a cooling fluid to the first cooling assembly. A control system is coupled to the first and second cooling assemblies. The control system is configured to channel cooling fluid from the second cooling assembly to the first cooling assembly when a temperature of air external to the housing is less than a temperature of air inside the housing, to facilitate reducing the air temperature inside the housing.

### BACKGROUND OF THE INVENTION

The subject matter described herein relates generally to appliances and, more particularly, to a cooling system for use in an appliance.

At least some known appliances, such as a refrigerator, include a cooling system that cools an interior volume of the appliance, such as, for example, a fresh food storage compartment and/or a freezer storage compartment of a refrigerator. At least some known cooling systems includes a vapor compression cycle system that cools the interior volume to a predefined temperature. Known vapor compression cycle systems include a refrigerant, an evaporator, a condenser, and a compressor that channels the refrigerant between the evaporator and the condenser.

During operation of known vapor compression cycle systems, air within the refrigerator is channeled across the evaporator to facilitate transferring heat from the air to the refrigerant. As heat is transferred from the air to the refrigerant, the refrigerant is vaporized. The compressor compresses the vaporized refrigerant and channels the refrigerant to the condenser, wherein heat is transferred from the refrigerant to ambient air surrounding the appliance to cool and condense the refrigerant.

At least some known appliances are located within an enclosure such as, for example, a house or garage, that has a controlled interior temperature. As the interior temperature of the house is increased, the demand is increased on the appliance which requires longer operating cycles and less time between operating cycles. As a result, an amount of power required to operate the vapor compression cycle system may be significantly increased.

### BRIEF DESCRIPTION OF THE INVENTION

In one embodiment, a cooling system for use in cooling an interior volume is provided. The cooling system includes a first cooling assembly that is positioned within a housing that defines the interior volume. The first cooling assembly facilitates cooling the interior volume of the housing. A second cooling assembly is positioned external to the housing in flow communication with the first cooling assembly. The second cooling assembly is configured to channel a cooling fluid to the first cooling assembly. A control system is coupled to the first and second cooling assemblies. The control system is configured to channel cooling fluid from the second cooling assembly to the first cooling assembly when a temperature of air external to the housing is less than a temperature of air inside the housing, to facilitate reducing the air temperature inside the housing.

In another embodiment, an appliance is provided. The appliance includes a housing that includes a plurality of interior walls that at least partially define an interior volume within the housing. A cooling system is coupled to the appliance. The cooling system includes a first cooling assembly that is positioned within the housing to facilitate cooling the interior volume of the housing. A second cooling assembly is positioned external to the housing in flow communication with the first cooling assembly. The second cooling assembly is configured to channel a cooling fluid to the first cooling assembly.

In yet another embodiment, a method of assembling a cooling system for use in cooling an interior volume of an appliance is provided. The method includes coupling a first cooling assembly to the appliance. The first cooling assembly is configured to cool the interior volume of the housing. A second cooling assembly is coupled to the first cooling assembly. The second cooling assembly is positioned external to of the housing and is configured to channel a cooling fluid to the first cooling assembly. A control system is coupled to the first and second cooling assemblies. The control system is configured to channel cooling fluid from the second cooling assembly to the first cooling assembly when a temperature of air external to the housing is less than a temperature of air inside the housing to facilitate reducing the air temperature inside the housing.

### BRIEF DESCRIPTION OF THE DRAWINGS

FIG. 1 is a perspective view of an exemplary appliance.

FIG. 2 is a schematic illustration of an exemplary cooling system that may be used with the appliance shown in FIG. 1.

FIG. 3 is a block diagram of the control system shown in FIG. 2.

### DETAILED DESCRIPTION OF THE INVENTION

The exemplary methods and systems described herein overcome at least some disadvantages of known appliance cooling systems by providing a cooling system that facilitates cooling a cooling fluid with ambient air surrounding the appliance. Moreover, the embodiments described herein include a cooling assembly that is positioned external to the appliance to cool the cooling fluid with ambient air when a temperature external to the appliance is determined to be less than a temperature within the appliance. The cooling assembly channels the cooling fluid to the appliance for use in reducing a temperature within the appliance. By using ambient air to cool the fluid, the operating cycle times of known vapor compression cycle systems are facilitated to be reduced, which also reduces the amount of power required to operate the vapor compression system systems and facilitates reducing the cost of cooling known refrigerators.

The present invention is described below connection with the operation of a household refrigerator. However, it will be apparent to those skilled in the art and guided by the teachings herein provided that the present invention is likewise applicable to any appliance including, without limitation, industrial refrigerators and refrigeration systems, freezers and any suitable industrial or household appliance.

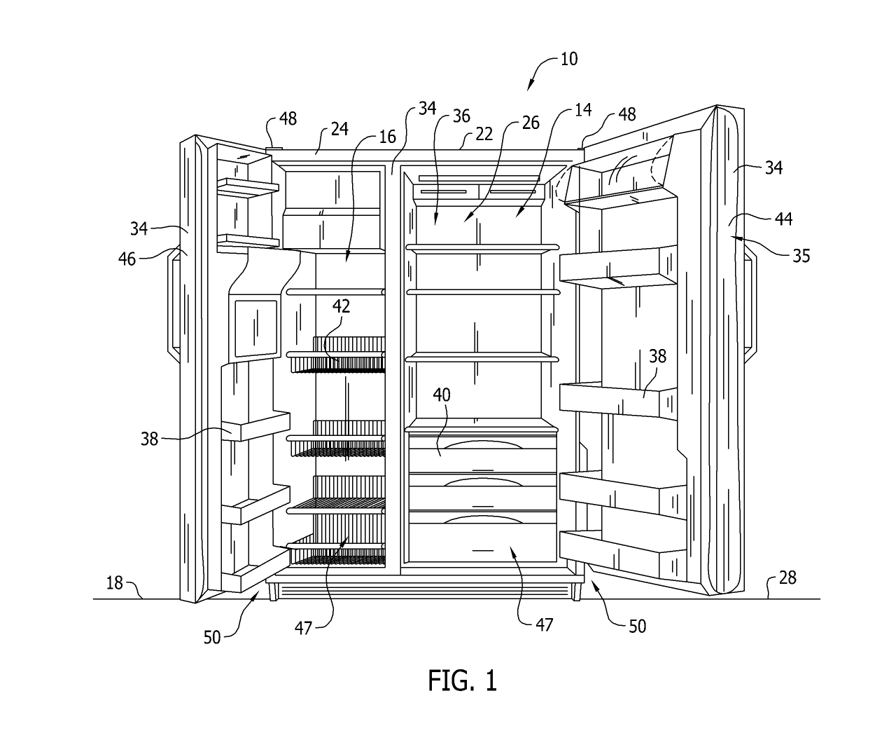

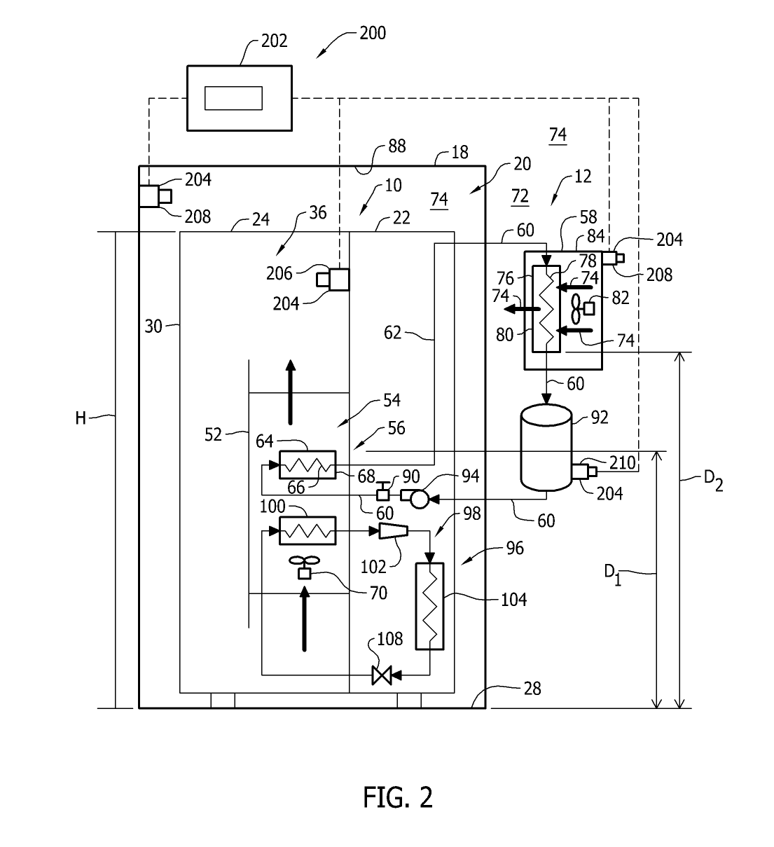

FIG. 1 is a perspective view of an exemplary appliance 10. FIG. 2 is a schematic illustration of an exemplary cooling system 12 that may be used with appliance 10. In the exemplary embodiment, appliance 10 is a refrigerator. However, it should be apparent to those skilled in the art and guided by the teachings herein that the present invention described herein, may likewise be practiced in any suitable appliance and is not limited to being practiced in only refrigerators. Therefore, refrigerator 10 as described and illustrated herein is for illustrative purposes only and is not intended to limit the herein described apparatus and/or method in any aspect. In one embodiment, refrigerator 10 is a commercially available refrigerator from General Electric Company, Appliance Park, Louisville, Ky. 40225 that has been modified to incorporate the herein described apparatus.

In the exemplary embodiment, appliance 10 includes a fresh food storage compartment 14 and freezer storage compartment 16 that are arranged in a side-by-side orientation. Alternatively, fresh food storage compartment 14 and freezer storage compartment 16 may be oriented in a top and bottom mount configuration and/or any other known orientation. Refrigerator 10 may be positioned within a structure 18 that has an interior volume 20, such as for example a house, a garage, a commercial building, and industrial building, a warehouse, and/or or any suitable structure that is sized to receive refrigerator 10 therein. In the exemplary embodiment, fresh food storage compartment 14 and freezer storage compartment 16 are each contained within a housing 22 that includes a plurality of walls 24 that are coupled together such that a cavity 26 is defined there within. Housing 22 is supported on a supporting surface 28 of structure 18, and includes an outer surface 30 that extends a height H above supporting surface 28. A plurality of inner liners 34 positioned within cavity 26 define an interior volume 36 of refrigerator 10. Inner liners 34 are oriented such that a space 35 defined between housing 22 and inner liners 34 is filled with insulation. In the exemplary embodiment, inner liners 34 are molded from a suitable plastic material to form fresh food storage compartment 14 and freezer storage compartment 16, respectively. In an alternative embodiment, inner liners 34 are formed by bending and welding a sheet of a suitable metal, such as steel. Refrigerator 10 also includes shelves 38, slide-out drawers 40, and wire baskets 42 that are each removably positioned within fresh food storage compartment 14 and freezer storage compartment 16 to support items being stored therein.

A fresh food door 44 and a freezer door 46 selectively close/seal openings 47 that provide access to fresh food storage compartment 14 and freezer storage compartment 16, respectively. Each door 44 and 46 is coupled to housing 22 by a top hinge 48 and a cooperating bottom hinge 50 to rotate about an outer vertical edge of housing 22 between an open position (shown in FIG. 1) that provides access to interior volume 36, and a closed position (not shown) that substantially isolates interior volume 36 from structure interior volume 20.

An air supply duct 52 positioned within housing 22 is coupled to fresh food storage compartment 14 and to freezer storage compartment 16. Air supply duct 52 at least partially defines an airflow path 54 that is used to supply cooled air to fresh food storage compartment 14 and to freezer storage compartment 16 to facilitate reducing a temperature within fresh food storage compartment 14 and freezer storage compartment 16.

In the exemplary embodiment, refrigerator 10 includes a cooling system 12 that is coupled to housing 22 to enable cooling air to be channeled through airflow path 54. Cooling system 12 includes a first cooling assembly 56 that is at least partially positioned within housing 22 and a second cooling assembly 58 that is positioned external to housing 22. First cooling assembly 56 reduces a temperature of interior volume 36. Second cooling assembly 58 is coupled to first cooling assembly 56 for channeling cooling fluid to first cooling assembly 56. A plurality of cooling fluid supply lines 60 are coupled between first cooling assembly 56 and second cooling assembly 58 such that a cooling circuit 62 is defined between first and second cooling assemblies 56 and 58. Cooling circuit 62 channels a flow of cooling fluid between first and second cooling assemblies 56 and 58. Cooling circuit 62 is charged with a cooling fluid that includes a propylene glycol. Alternatively, the cooling fluid may include an ethylene glycol, an isopropyl alcohol based fluids, and/or any suitable fluid that enables cooling system 12 to function as described herein.

In the exemplary embodiment, first cooling assembly 56 includes a heat exchanger 64 that is within housing 22 and that transfers heat from the air being channeled through airflow path 54 to the cooling fluid to facilitate cooling interior volume 36. Heat exchanger 64 is positioned within airflow path 54 and includes a plurality of pipelines 66 that channel cooling fluid through heat exchanger 64. Pipelines 66 are positioned within a casing 68 that channels air across an outer surface of each pipeline 66. First cooling assembly 56 also includes a fan 70 that is positioned within airflow path 54 for use in channeling air through airflow path 54 and across pipelines 66 to facilitate reducing a temperature of air as the air passes through heat exchanger 64.

Second cooling assembly 58 is positioned external to housing 22 and reduces a temperature of the cooling fluid by transferring heat from cooling fluid to air. In the exemplary embodiment, second cooling assembly 58 is positioned in an area 72 defined external to structure 18, and that is in flow communication with ambient air 74 flowing past structure 18. In an alternative embodiment, second cooling assembly 58 is positioned within structure interior volume 20, such that second cooling assembly 58 is in flow communication with ambient air 74 external to housing 22 that is contained within structure 18 and interior volume 20.

In the exemplary embodiment, second cooling assembly 58 includes a heat exchanger 76 that is in area 72 and that is in flow communication with ambient air 74. Heat exchanger 76 includes a plurality of pipelines 78 that are positioned within a casing 80. Pipelines 78 channel cooling fluid through heat exchanger 76. Casing 80 facilitates channeling ambient air 74 across an outer surface of each pipeline 78. Moreover, heat exchanger 76 transfers heat from the cooling fluid flowing therethrough to ambient air 74 flowing past pipelines 78. Second cooling assembly 58 also includes a fan 82 that channels ambient air 74 across pipelines 78 to facilitate reducing a temperature of the cooling fluid. In one embodiment, heat exchanger 76 and fan 82 are each positioned within an enclosure 84 that is coupled to an outer surface 86 of structure 18. Alternatively, second cooling assembly 58 may be positioned within structure 18 and/or coupled to an inner surface 88 of structure 18, and/or supported from supporting surface 28.

Cooling system 12 also includes a valve assembly 90 coupled between first cooling assembly 56 and second cooling assembly 58. Valve assembly 90 enables a flow of cooling fluid to be selectively channeled from second cooling assembly 58 to first cooling assembly 56. Valve assembly 90 is movable between a first valve position that enables a flow of cooling fluid to be channeled from second cooling assembly 58 to first cooling assembly 56, and a second valve position that prevents cooling fluid from being channeled from second cooling assembly 58 to first cooling assembly 56.

A reservoir 92 is defined in flow communication between first cooling assembly 56 and second cooling assembly 58. Reservoir 92 facilitates accommodating a thermal expansion of cooling fluid being channeled from second cooling assembly 58 to first cooling assembly 56, and thus facilitates regulating a fluid pressure within cooling circuit 62.

In the exemplary embodiment, cooling system 12 includes a pump assembly 94 coupled between first cooling assembly 56 and second cooling assembly 58. Pump assembly 94 increases a pressure of cooling fluid within cooling circuit 62 and channels the pressurized cooling fluid from second cooling assembly 58 to first cooling assembly 56, through cooling circuit 62 and returned to second cooling assembly 58. In one embodiment, first cooling assembly 56 is a first distance D₁ from supporting surface 28, and second cooling assembly 58 is a second distance D₂ from supporting surface 28. In the exemplary embodiment, second distance D₂ is longer than first distance D₁ to enable cooling fluid to be gravity fed through cooling circuit 62. As cooling fluid is channeled through second cooling assembly 58, a fluid density of the cooling fluid is increased, causing the cooling fluid to descend and flow within cooling circuit 62 towards first cooling assembly 56. As the cooling fluid is channeled through first cooling assembly 56, the cooling fluid is heated which decreases a fluid density and causes the cooling fluid to rise within cooling circuit 62 towards second cooling assembly 58. In the exemplary embodiment, cooling system 12 is electrically coupled to a power load such as, for example, a utility power grid. In an alternative embodiment, cooling system 12 includes a back-up battery power supply coupled to first cooling assembly 56, second cooling assembly 58, valve assembly 90, and reservoir 92 to enable cooling system 12 to operate during a utility grid power loss.

In the exemplary embodiment, cooling system 12 includes a third cooling assembly 96 that is at least partially positioned within refrigerator housing 22 and that reduces a temperature of refrigerator interior volume 36. Third cooling assembly 96 includes a vapor compression cycle system 98 that cools air being channeled through air supply duct 52 into interior volume 36. Vapor compression cycle system 98 includes at least one evaporator 100, a compressor 102, a condenser 104, and an expansion valve 108 that are each coupled in series with, and charged with, a refrigerant. Vapor compression cycle system 98 is positioned within airflow path 54 for transferring heat from air within airflow path 54 to the refrigerant, as air is channeled across evaporator 100. Evaporator 100 transfers heat from air passing over evaporator 100 to a refrigerant flowing through evaporator 100, thereby causing the refrigerant to vaporize. Evaporator 100 is adjacent to heat exchanger 64 and to fan 70, such that fan 70 channels air across heat exchanger 64 and across evaporator 100 to cool air channeled through airflow path 54.

In the exemplary embodiment, cooling system 12 includes a control system 200. Control system 200 includes a controller 202 that is coupled in communication with one or more sensors 204. Each sensor 204 senses various parameters relative to the operation and environmental conditions of refrigerator 10, interior volumes 20 and 36, and cooling system 12. Sensors 204 may include, but are not limited to only including, temperature sensors, flow sensors, fluid pressure sensors 204, valve position sensors, and/or any other sensors that sense various operating parameters relative to the operation of cooling system 12. As used herein, the term “parameters” refers to physical properties whose values can be used to define the operating and environmental conditions of refrigerator 10, interior volumes 20 and 36, and cooling system 12, such as temperatures, fluid pressures, and fluid flows at defined locations. In the exemplary embodiment, control system 200 is coupled in operative communication to first, second, and third cooling assemblies 56, 58, and 96, respectively, to valve assembly 90, and to pump assembly 94 to enable an air temperature within interior volumes 20 and/or 36, to be selectively adjusted, a flow of cooling fluid within cooling circuit 62 to be controlled, and a temperature of cooling fluid to be selectively adjusted. Control system 200 is electrically coupled to a utility power grid. In one embodiment, control system 200 is coupled to a back-up battery power supply to enable control system 200 to operate cooling system 12 during a utility grid power loss.

Control system 200 includes a first sensor 206 that is within housing 22. First sensor 206 senses an air temperature within refrigerator interior volume 36 and transmits a signal indicative of the sensed air temperature to controller 202. A second sensor 208 is positioned external to housing 22 in flow communication with ambient air 74. Second sensor 208 senses an air temperature external to housing 22 and transmits a signal indicative of the sensed external air temperature to controller 202. A third sensor 210 is coupled to cooling circuit 62 for sensing a fluid temperature of cooling fluid within cooling circuit 62 and for transmitting a signal indicative of a sensed fluid temperature to controller 202.

Control system 200 channels cooling fluid from second cooling assembly 58 to first cooling assembly 56 to facilitate cooling interior volume 36 when a sensed temperature external to housing 22 is less than a sensed temperature within interior volume 36. In one embodiment, control system 200 channels cooling fluid from second cooling assembly 58 to first cooling assembly 56 when a sensed temperature external to housing 22 is at least 30° Fahrenheit less than a sensed temperature within interior volume 36.

In an alternative embodiment, control system 200 operates vapor compression cycle system 98 to facilitate cooling interior volume 36 when a sensed air temperature within interior volume 36 is approximately equal to, or greater than, a predefined air temperature within interior volume 36. Control system 200 also operates first and second cooling assemblies 56 and 58 when the sensed temperature external to housing 22 is less than the sensed temperature within housing 22, to facilitate cooling interior volume 36. In the exemplary embodiment, control system 200 operates vapor compression cycle system 98 and first and second cooling assemblies 56 and 58 concurrently to facilitate cooling interior volume 36. Control system 200 also shuts-down third cooling assembly 96 when first and second cooling assemblies are being operated to cool interior volume 36.

In an alternative embodiment, second sensor 208 and second cooling assembly 58 are each external to housing 22 and within structure 18 such that second sensor and second cooling assembly 58 are in flow communication with interior volume 20. Second sensor 208 senses an air temperature within interior volume 20 and transmits a signal indicative of the sensed air temperature to controller 202. Control system 200 channels cooling fluid from second cooling assembly 58 to first cooling assembly 56 when the sensed temperature within interior volume 20 is less than a sensed temperature within refrigerator interior volume 36.

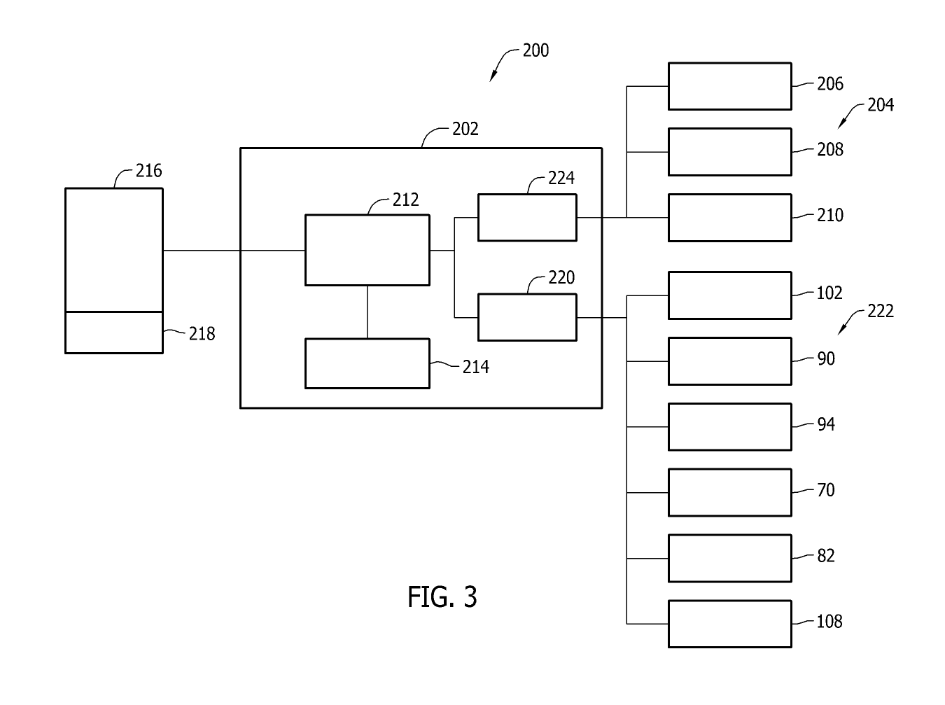

FIG. 3 is a block diagram of control system 200. In the exemplary embodiment, controller 202 includes a processor 212 and a memory device 214. Processor 212 includes any suitable programmable circuit which may include one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.” Memory device 214 includes a computer readable medium, such as, without limitation, random access memory (RAM), flash memory, a hard disk drive, a solid state drive, a diskette, a flash drive, a compact disc, a digital video disc, and/or any suitable device that enables processor 212 to store, retrieve, and/or execute instructions and/or data.

Controller 202 also includes a display 216 and a user interface 218. Display 216 may include a vacuum fluorescent display (VFD) and/or one or more light-emitting diodes (LED). Additionally or alternatively, display 216 may include, without limitation, a liquid crystal display (LCD), a cathode ray tube (CRT), a plasma display, and/or any suitable visual output device capable of displaying graphical data and/or text to a user. In an exemplary embodiment, a temperature of refrigerator interior volumes 20 and 36, an external air temperature, an operating status of cooling system 12, a temperature of fresh food storage compartment 14, a temperature of freezer storage compartment 16, and/or any other information may be displayed to a user on display 216. User interface 218 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into controller 202 and/or to retrieve data from controller 202. In an exemplary embodiment, the user may input a predefined temperature setting for interior volume 36, fresh food storage compartment 14, and/or freezer storage compartment 16 using user interface 218. Moreover, the user may operate user interface 218 to initiate and/or terminate an operation of cooling system 12. Display 216 and user interface 218 may be coupled to housing outer surface 30 such as fresh food door 44 and/or freezer door 46, and/or any suitable location such that display 216 and user interface 218 are accessible to a user.

In the exemplary embodiment, controller 202 includes a control interface 220 that controls an operation of cooling system 12. In some embodiments, control interface 220 is coupled to one or more control devices 222, such as, for example, valve assembly 90, pump assembly 94, fans 70 and 82, compressor 102, and/or expansion valve 108, respectively. Controller 202 also includes a sensor interface 224 that is coupled to at least one sensor 204 such as, for example, first, second, and third sensors 206, 208, and 210. Each sensor 204 transmits a signal corresponding to a sensed operating parameter of cooling system 12 and/or refrigerator 10. Each sensor 204 may transmit a signal continuously, periodically, or only once, for example, although other signal timings are also contemplated. Moreover, each sensor 204 may transmit a signal either in an analog form or in a digital form.

Various connections are available between control interface 220 and control device 222, between sensor interface 224 and sensors 204, and between processor 212 and display 216 and/or user interface 218. Such connections may include, without limitation, an electrical conductor, a low-level serial data connection, such as Recommended Standard (RS) 232 or RS-485, a high-level serial data connection, such as Universal Serial Bus (USB) or Institute of Electrical and Electronics Engineers (IEEE) 1394 (a/k/a FIREWIRE), a parallel data connection, such as IEEE 1284 or IEEE 488, a short-range wireless communication channel such as BLUETOOTH, and/or a private (e.g., inaccessible outside appliance 10) network connection, whether wired or wireless.

During operation of cooling system 12, controller 202 receives a signal from first sensor 206 that is indicative of a temperature within interior volume 36. Processor 212 determines whether the sensed temperature within interior volume 36 is greater than a predefined temperature and operates cooling system 12 to facilitate reducing an air temperature within interior volume 36 if the sensed interior volume temperature is greater than the predefined temperature. Controller 202 also receives a signal from second sensor 208 that is indicative of an air temperature external to housing 22. Processor 212 determines whether the sensed external air temperature is less than the sensed interior volume temperature. Processor 212 operates first and second cooling assemblies 56 and 58 to facilitate reducing a temperature within interior volume 36 if the sensed temperature external to housing 22 is less than the sensed temperature inside housing 22. Moreover, processor 212 operates third cooling assembly 96 to facilitate cooling interior volume 36 if the sensed temperature external to housing is substantially equal to or greater than the sensed temperature within housing 22. In an alternative embodiment, controller 202 receives a signal from third sensor 210 that is indicative of a fluid temperature of cooling fluid within cooling circuit 62 and operates first and second cooling assemblies 56 and 58 if the sensed cooling fluid temperature is less than the sensed interior volume temperature.

An exemplary technical effect of the methods, system, and apparatus described herein includes at least one of: (a) transmitting, from a sensor to a controller, a first monitoring signal indicative of a temperature within a refrigerator; (b) transmitting, from the sensor to the controller, a second monitoring signal indicative of a temperature external to the refrigerator; (c) determining, by the controller, whether the sensed temperature external to the refrigerator is less than the sensed temperature within the refrigerator; and (d) channeling a cooling fluid from a cooling assembly positioned external to the refrigerator to a cooling assembly positioned within the refrigerator to facilitate reducing the temperature within the refrigerator when the sensed temperature external to the refrigerator is less than the sensed temperature within the refrigerator.

The orientation and position of first and second cooling assemblies 56 and 58 is selected to enable refrigerator interior volume 36 to be cooled with ambient air external to refrigerator 10 that includes a temperature that is less than a temperature of interior volume 36. By channeling the ambient air across a cooling fluid, and channeling the cooling fluid to interior volume 36, the ambient air external to refrigerator facilitates cooling interior volume 36. By using the external air to cool interior volume 36, the power required and cost of cooling refrigerator 10 is facilitated to be reduced.

The above-described systems and methods overcome at least some disadvantages of known refrigerator cooling systems by providing a cooling system that uses ambient air external to the refrigerator to facilitate cooling the refrigerator interior volume. More specifically, the cooling system described herein includes a cooling assembly that is positioned external to the appliance and in flow communication with the ambient air to facilitate cooling a cooling fluid with the ambient air when a temperature outside the appliance is less than a temperature within the appliance, and channel the cooled fluid to the refrigerator to reduce a temperature within the refrigerator. As such, the duration and frequency of operating a vapor compression cycle system in known refrigerators is facilitated to be reduced, thus reducing the cost of cooling the refrigerator.

Exemplary embodiments of a cooling system for use with an appliance and methods of assembling the cooling system are described above in detail. The systems and methods are not limited to the specific embodiments described herein, but rather, components of the systems and/or steps of the methods may be utilized independently and separately from other components and/or steps described herein. For example, the methods may also be used in combination with other appliance systems, and are not limited to practice with only the appliance system as described herein. Rather, the exemplary embodiment can be implemented and utilized in connection with many other cooling system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A cooling system for use in cooling an interior volume, said cooling system comprising:
a first cooling assembly positioned within a housing defining the interior volume; said first cooling assembly facilitates cooling the interior volume of the housing;
a second cooling assembly positioned external to the housing in flow communication with said first cooling assembly, said second cooling assembly configured to channel a cooling fluid to said first cooling assembly; and
a control system coupled to said first and second cooling assemblies, said control system configured to channel cooling fluid from said second cooling assembly to said first cooling assembly when a temperature of air external to the housing is less than a temperature of air inside the housing, to facilitate reducing the air temperature inside the housing.

2. A cooling system in accordance with claim 1, wherein said second cooling assembly comprises a heat exchanger configured to channel a flow of ambient air across the cooling fluid to facilitate reducing a temperature of the cooling fluid.

3. A cooling system in accordance with claim 1, further comprising a battery power supply coupled to said first and second cooling assemblies and to said control system.

4. A cooling system in accordance with claim 1, further comprising a valve assembly coupled between said first cooling assembly and said second cooling assembly to enable a flow of cooling fluid to be selectively channeled from said second cooling assembly to said first cooling assembly.

5. A cooling system in accordance with claim 4, further comprising a reservoir coupled between said first cooling assembly and said second cooling assembly to accommodate thermal expansion of cooling fluid channeled from said second cooling assembly to said first cooling assembly.

6. A cooling system in accordance with claim 5, further comprising a pump assembly coupled between said first cooling assembly and said second cooling assembly, said pump assembly facilitates channeling cooling fluid through said cooling circuit.

7. A cooling system in accordance with claim 1, wherein said control system comprises:
a first sensor configured to sense a first air temperature within the housing and to generate a signal indicative of the sensed interior temperature; and
a second sensor configured to sense a second air temperature external to the housing and to generate a signal indicative of the sensed exterior temperature.

8. A cooling system in accordance with claim 7, wherein said control system is configured to channel a flow of cooling fluid to said first cooling assembly when the sensed exterior air temperature is about 30° Fahrenheit less than the sensed interior air temperature.

9. An appliance comprising:
a housing comprising a plurality of interior walls that at least partially define an interior volume within said housing; and
a cooling system coupled to said appliance, said cooling system comprising:
a first cooling assembly positioned within said housing to facilitate cooling the interior volume of said housing; and
a second cooling assembly positioned external to said housing in flow communication with said first cooling assembly, said second cooling assembly configured to channel a cooling fluid to said first cooling assembly.

10. An appliance in accordance with claim 9, further comprising a third cooling assembly coupled to said housing for cooling the interior volume of said housing.

11. An appliance in accordance with claim 9, further comprising a control system coupled to said first and second cooling assemblies, said control system configured to channel cooling fluid from said second cooling assembly to said first cooling assembly when a temperature of air external to said housing is less than a temperature of air inside said housing, to facilitate reducing the air temperature inside said housing.

12. An appliance in accordance with claim 11, wherein said control system is configured to channel cooling fluid to said first cooling assembly when the sensed exterior air temperature is about 30° Fahrenheit less than the sensed interior air temperature.

13. An appliance in accordance with claim 9, wherein said second cooling assembly comprises a heat exchanger configured to channel a flow of ambient air across the cooling fluid to facilitate reducing a temperature of the cooling fluid.

14. An appliance in accordance with claim 9, further comprising a valve assembly coupled between said first cooling assembly and said second cooling assembly to enable a flow of cooling fluid to be selectively channeled from said second cooling assembly to said first cooling assembly.

15. An appliance in accordance with claim 9, further comprising a reservoir coupled between said first cooling assembly and said second cooling assembly to accommodate thermal expansion of the cooling fluid channeled from said second cooling assembly to said first cooling assembly.

16. An appliance in accordance with claim 9, further comprising a pump assembly coupled between said first cooling assembly and said second cooling assembly for channeling the cooling fluid from said second cooling assembly to said first cooling assembly.

17. A method of assembling a cooling system for use in cooling an interior volume of an appliance, said method comprising:
coupling a first cooling assembly to the appliance, the first cooling assembly configured to cool the interior volume of the housing;
coupling a second cooling assembly to the first cooling assembly, the second cooling assembly positioned external to the housing and configured to channel a cooling fluid to the first cooling assembly; and
coupling a control system to the first and second cooling assemblies, the control system configured to channel cooling fluid from the second cooling assembly to the first cooling assembly when a temperature of air external to the housing is less than a temperature of air inside the housing, to facilitate reducing the air temperature inside the housing.

18. A method in accordance with claim 17, further comprising coupling a valve assembly between the first cooling assembly and the second cooling assembly, the valve assembly configured to enable a flow of cooling fluid to be selectively channeled from the second cooling assembly to the first cooling assembly.

19. A method in accordance with claim 17, further comprising coupling a reservoir between the first cooling assembly and the second cooling assembly to accommodate a thermal expansion of the cooling fluid channeled from the second cooling assembly to the first cooling assembly.

20. A method in accordance with claim 17, further comprising coupling a pump assembly between the first cooling assembly and the second cooling assembly, the pump assembly facilitates channeling cooling fluid from the second cooling assembly to the first cooling assembly.
